(19) United States
(12) Patent Application Publication
(10) Pub. No.: US 2015/0028710 A1
(43) Pub. Date: Jan. 29, 2015

(54) ROTOR FOR ROTATING ELECTRIC MACHINE, ROTATING ELECTRIC MACHINE, AND METHOD FOR MANUFACTURING ROTOR FOR ROTATING ELECTRIC MACHINE

(71) Applicants: Keiichiro Oka, Chiyoda-ku (JP); Hiroyuki Akita, Chiyoda-ku (JP)

(72) Inventors: Keiichiro Oka, Chiyoda-ku (JP); Hiroyuki Akita, Chiyoda-ku (JP)

(73) Assignee: Mitsubishi Electric Corporation, Chiyoda-ku, Tokyo (JP)

(21) Appl. No.: 14/378,787

(22) PCT Filed: Mar. 13, 2013
(86) PCT No.: PCT/JP2013/056938

§ 371 Date: Aug. 14, 2014

(30) Foreign Application Priority Data
May 24, 2012 (JP) 2012-118194

(51) Int. Cl. H02K 1/27; H02K 15/03

(52) U.S. Cl. CPC H02K 1/27; H02K 15/03
USPC 310/156.48; 29/598

(57) ABSTRACT

Provided is a rotor for a rotating electric machine which includes: an N pole integrally-stacked core in which a plurality of stacked tooth portions that contact with N pole side portions of adjacent ones of first permanent magnets are integrated with each other; and an S pole integrally-stacked core in which a plurality of stacked tooth portions that contact with S pole side portions of adjacent ones of the first permanent magnets are integrated with each other, and in which the N pole integrally-stacked core and the S pole integrally-stacked core are disposed around a rotation shaft having a non-magnetic outer circumferential surface so as to dispose the first permanent magnets and a gap therebetween.

### TECHNICAL FIELD

The present invention relates to a rotor for a rotating electric machine, a rotating electric machine, and a method for manufacturing a rotor for a rotating electric machine.

### BACKGROUND ART

To date, as one of methods for reducing a size of a rotor for an electric motor and enhancing performance of the rotor, a technique has been suggested in which a rotor including a plurality of permanent magnets and a plurality of stacked core members that are alternately disposed, is used to efficiently utilize magnetic fields of the permanent magnets, and the plurality of permanent magnets are magnetized around a rotation shaft in an alternate manner in the circumferential direction, and the plurality of stacked core members each form a magnetic pole between the permanent magnets.

In this type of rotors, the stacked core members are formed by stacked components of almost sector-shaped thin plate core pieces, such as silicon steel plates, formed of a magnetic material, being integrated with each other by swaging using a press machine.

In this case, each permanent magnet is sandwiched between the adjacent stacked core members in close contact with the side surfaces thereof, and is in general positioned in a radial direction and fixed by means of outer hooks and inner hooks that project from the side surfaces in an outer circumferential portion and an inner circumferential portion of each stacked core member so as to correspond to the shape of the permanent magnet.

Further, tie rods are inserted so as to pass through the stacked core members in an axial direction at almost the center portion of each stacked core member, and the tie rods are disposed at both ends in the axial direction of each stacked core member, and are fastened to annular end plates fixed to the rotation shaft, whereby the stacked core members and the permanent magnets are held by and fixed to each other so as to be against a centrifugal force, a rotation torque, or a counterforce of the rotation torque.

In this assembling process, there is a problem that positioning and fixing of each permanent magnet and each stacked core member are complicated, to increase an operating time.

Further, a worker is required to be skilled, and a problem arises that manpower saving and productivity improvement are prevented.

Positioning accuracy for each permanent magnet and each stacked core member depends only on mechanical strengths of and processing accuracy for the tie rods and the end plates.

In particular, for use in a high speed electric motor or a high torque electric motor, mechanical strength of the entirety of the rotor needs to be further enhanced so as to retain the plurality of stacked core members and permanent magnets at predetermined positions.

In order to attain this object, a rotor for an electric motor has been suggested in which the stacked core members are connected to each other by at least one integral-type thin plate core that intervenes at and connects to a predetermined position of a stacked component of thin plate core pieces which form each stacked core member, and the integral-type thin plate core includes: thin plate core piece portions, each having the same shape as the thin plate core piece, which are provided in the same number as the number of magnetic poles so as to intervene in and connect to a stacked structure of the thin plate core pieces; and a connecting portion that extends from each thin plate core piece portion and annularly connects all the thin plate core piece portions in such a relative positional relationship as to form, between the adjacent thin plate core piece portions, spaces for setting the permanent magnets, thereby forming, between the adjacent stacked core members, spaces for setting the permanent magnets (for example, Patent Document 1).

When the rotor has such a structure, positioning of each stacked core member can be performed while magnetic flux leakage of each permanent magnet can be minimized, to enable improvement of assembling efficiency.

### CITATION LIST

### Patent Document

Patent Document 1: Japanese Laid-Open Patent Publication No. 06-245451 (FIG. 1, FIG. 16, FIG. 19)

### SUMMARY OF THE INVENTION

### Problems to be Solved by the Invention

In the rotor for the electric motor as described in Patent Document 1, the stacked core members are connected to each other by means of the integral-type thin plate core, to enable improvement of assembling efficiency. However, magnetic flux leakage of the permanent magnets due to the integral-type thin plate core that may form a magnetic path connecting between an N pole and an S pole of the permanent magnet is still unavoidable, and there is a problem that deterioration of characteristic of the electric motor cannot be avoided.

Further, Patent Document 1 discloses a structure of another embodiment in which a magnetic path connecting between an N pole and an S pole is not directly formed. However, in the structure, an area for fitting to the rotation shaft is small, and rigidity of the annular connecting portion of the integral-type thin plate core is significantly reduced as described in the document. Therefore, there is a problem that deterioration of assembling efficiency cannot be avoided, and a structure is such that thin plate cores having complicated shapes are combined, thereby reducing productivity.

The present invention is made in order to solve the aforementioned problem, and an object of the present invention is to provide a rotor, for a rotating electric machine, in which an annular connecting portion does not form a magnetic path connecting between an N pole and an S pole of a permanent magnet, and stacked teeth have a high rigidity and a simple shape, and a group of the stacked teeth and a rotation shaft can be fitted and assembled so as to be assuredly concentric with each other, to obtain an excellent assembling efficiency and productivity.

### Solution to the Problems

A rotor for a rotating electric machine according to the present invention includes:

a plurality of first permanent magnets disposed around a rotation shaft so as to be equally spaced from each other, and magnetized alternately in a circumferential direction; and

a stacked core having a plurality of stacked tooth portions disposed around the rotation shaft so as to sandwich the first permanent magnets from the circumferential direction, and each stacked tooth portion forming a magnetic pole,

the stacked core

includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other,

each of the N pole integrally-stacked core and the S pole integrally-stacked core includes:

a magnetic connecting tooth piece that has: an annular connecting portion which is disposed around the rotation shaft and enables a corresponding one of the integrally stacked cores to be positioned relative to the rotation shaft; and first tooth portions which are equally spaced from each other and disposed so as to project from the annular connecting portion outward in the circumferential direction of the rotation shaft; and

first tooth pieces each of which is magnetic and has a shape formed by an end portion, on the rotation shaft side, of the first tooth portion being cut in the circumferential direction of the rotation shaft with a predetermined width, and which are stacked so as to be aligned with an outer circumference of the first tooth portions,

in each of the N pole integrally-stacked core and the S pole integrally-stacked core,

the first tooth pieces are stacked on the first tooth portions, of the connecting tooth piece, stacked so as to have a thickness that is less than or equal to half a length, in an axial direction, of the stacked core, and a thickness that is the same between the N pole integrally-stacked core and the S pole integrally-stacked core, such that the first tooth pieces are stacked so as to have a thickness that is the same between the N pole integrally stacked core and the S pole integrally-stacked core, and

the N pole integrally-stacked core and the S pole integrally-stacked core are disposed around the rotation shaft having a non-magnetic outer circumferential surface such that the annular connecting portion is disposed on an outer side, and the stacked tooth portions of the N pole integrally-stacked core and the stacked tooth portions of the S pole integrally-stacked core are alternately disposed so as to face each other, and to sandwich the first permanent magnets therebetween.

Further, a rotating electric machine according to the present invention includes a rotor and a stator, and the rotor includes:

a plurality of first permanent magnets disposed around a rotation shaft so as to be equally spaced from each other, and magnetized alternately in a circumferential direction; and

a stacked core having a plurality of stacked tooth portions disposed around the rotation shaft so as to sandwich the first permanent magnets from the circumferential direction, and each stacked tooth portion forming a magnetic pole,

the stacked core

includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other,

each of the N pole integrally-stacked core and the S pole integrally-stacked core includes:

a magnetic connecting tooth piece that has: an annular connecting portion which is disposed around the rotation shaft and enables a corresponding one of the integrally stacked cores to be positioned relative to the rotation shaft; and first tooth portions which are equally spaced from each other and disposed so as to project from the annular connecting portion outward in the circumferential direction of the rotation shaft; and

first tooth pieces each of which is magnetic and has a shape formed by an end portion, on the rotation shaft side, of the first tooth portion being cut in the circumferential direction of the rotation shaft with a predetermined width, and which are stacked so as to be aligned with an outer circumference of the first tooth portions,

in each of the N pole integrally-stacked core and the S pole integrally-stacked core,

the first tooth pieces are stacked on the first tooth portions, of the connecting tooth piece, stacked so as to have a thickness that is less than or equal to half a length, in an axial direction, of the stacked core, and a thickness that is the same between the N pole integrally-stacked core and the S pole integrally-stacked core, such that the first tooth pieces are stacked so as to have a thickness that is the same between the N pole integrally-stacked core and the S pole integrally-stacked core, and

the N pole integrally-stacked core and the S pole integrally-stacked core are disposed around the rotation shaft having a non-magnetic outer circumferential surface such that the annular connecting portion is disposed on an outer side, and the stacked tooth portions of the N pole integrally-stacked core and the stacked tooth portions of the S pole integrally-stacked core are alternately disposed so as to face each other, and to sandwich the first permanent magnets therebetween.

Further, in a method for manufacturing a rotor for a rotating electric machine according to the present invention, the rotor for the rotating electric machine includes:

a plurality of first permanent magnets disposed around a rotation shaft so as to be equally spaced from each other, and magnetized alternately in a circumferential direction; and

a stacked core having a plurality of stacked tooth portions disposed around the rotation shaft so as to sandwich the first permanent magnets from the circumferential direction, and each stacked tooth portion forming a magnetic pole, and

the stacked core

includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other, and

the method for manufacturing a rotor for a rotating electric machine includes:

a manufacturing step of manufacturing each of the N pole integrally-stacked core and the S pole integrally-stacked core;

a stacked core fitting step; and

a permanent magnet inserting step, and

the manufacturing step includes:

a connecting tooth piece stacking step of stacking magnetic connecting tooth pieces each having an annular connecting portion and first tooth portions, so as to have a thickness that is less than or equal to half a length, in an axial direction, of the stacked core, and a thickness that is the same between the N pole integrally-stacked core and the S pole integrally-stacked core, the annular connecting portion being disposed around the non-magnetic rotation shaft and enabling a corresponding one of the integrally stacked cores to be positioned relative to the rotation shaft, the first tooth portions being equally spaced from each other and disposed so as to project from the annular connecting portion outward in the circumferential direction of the rotation shaft;

a first tooth piece stacking step of stacking, on the first tooth portions of the connecting tooth pieces, first tooth pieces each of which is magnetic and has a shape formed by an end portion, on the annular connecting portion side, of the first tooth portion being cut in the circumferential direction of the rotation shaft with a predetermined width, such that the first tooth pieces are aligned with an outer circumference of the first tooth portions, and have a thickness that is the same between the N-pole integrally-stacked core and the S-pole integrally stacked core, to structure the stacked tooth portions, and

after one of the N pole integrally-stacked core and the S pole integrally-stacked core is positioned relative to and fitted to the rotation shaft such that the annular connecting portion is disposed on an outer side of the rotation shaft,

in the stacked core fitting step, the other of the integrally stacked cores is positioned relative to and fitted to the rotation shaft such that the annular connecting portion is disposed on the outer side of the rotation shaft, and the stacked tooth portions of the N pole integrally-stacked core and the stacked tooth portions of the S pole integrally-stacked core are alternately disposed in the circumferential direction of the rotor at regular intervals so as to face each other, and

in the permanent magnet inserting step, the first permanent magnets are inserted, from an axial direction of the rotation shaft, in spaces formed between the stacked tooth portions of the N pole integrally-stacked core and the stacked tooth portions of the S pole integrally-stacked core, such that an N pole of the first permanent magnets contacts with the N pole integrally-stacked core and an S pole of the first permanent magnets contacts with the S pole integrally-stacked core.

### Effect of the Invention

In the rotor for the rotating electric machine, the rotating electric machine, and the method for manufacturing the rotor for the rotating electric machine according to the present invention,

one of the permanent magnet or the gap, and the rotation shaft formed of a non-magnetic material is disposed between the N pole integrally-stacked core and the S pole integrally-stacked core, and therefore short-circuiting of the N pole and the S pole of the permanent magnets due to a magnetic material of the iron core piece or the like forming the stacking, does not occur.

Further, the N pole integrally-stacked core and the S pole integrally-stacked core are positioned and fixed by the annular connecting portions and the rotation shaft being fitted to each other and assembled. Therefore, as compared to, for example, a case where the N pole integrally-stacked core and the S pole integrally-stacked core, and end surface plates that are disposed on the end surfaces, in the axial direction, of each of the N pole integrally-stacked core and the S pole integrally-stacked core, and that are fitted and fixed to the rotation shaft, are assembled and fixed by, for example, tie rods being inserted, or a case where the N pole integrally-stacked core and the S pole integrally-stacked core are fixed to the rotation shaft by integral forming with the use of a mold resin or the like, positioning accuracy and the number of assembling process steps are advantageous, concentricity of the rotor and assembling efficiency can be enhanced, and lead time can be reduced in the manufacturing.

### BRIEF DESCRIPTION OF THE DRAWINGS

FIG. 1 is a perspective view of a rotor for a rotating electric machine according to embodiment 1 of the present invention.

FIG. 2 is an exploded perspective view of the rotor for the rotating electric machine according to embodiment 1 of the present invention.

FIG. 3 is a plane view of the rotor for the rotating electric machine according to embodiment 1 of the present invention.

FIG. 4 is a perspective view of an N pole integrally-stacked core and an S pole integrally-stacked core of the rotor for the rotating electric machine according to embodiment 1 of the present invention.

FIG. 5 is a plan view of a tooth piece of the rotor for the rotating electric machine according to embodiment 1 of the present invention.

FIG. 6 is a perspective sectional view of the rotor as taken along a line A-A in FIG. 3.

FIG. 7 is a sectional view of the rotor as taken along a line B-B in FIG. 3.

FIG. 8 is a sectional view of the rotor as taken along a line C-C in FIG. 3.

FIG. 9 illustrates another example of a first permanent magnet for use in the rotor for the rotating electric machine according to embodiment 1 of the present invention.

FIG. 10 is a sectional view of a rotor for a rotating electric machine according to embodiment 2 of the present invention.

FIG. 11 is a sectional view of a rotor for a rotating electric machine according to embodiment 3 of the present invention.

FIG. 12 is an enlarged view of a specific portion in FIG. 11.

FIG. 13 is a sectional view of a rotor for a rotating electric machine according to embodiment 4 of the present invention.

FIG. 14 is a sectional view of a rotor for a rotating electric machine according to embodiment 5 of the present invention.

FIG. 15 is a perspective view of a rotor for a rotating electric machine according to embodiment 6 of the present invention,

FIG. 16 is a perspective view of an N pole integrally-stacked core and an S pole integrally-stacked core according to embodiment 6 of the present invention.

FIG. 17 is a plan view of the rotor for the rotating electric machine according to embodiment 6 of the present invention.

FIG. 18 is an enlarged view of a specific portion in FIG. 17.

FIG. 19 is a sectional view of the rotor as taken along a line D-D in FIG. 17.

FIG. 20 is an enlarged view of a specific portion of the rotor in FIG. 19.

FIG. 21 is a perspective view of a rotor according to embodiment 7 of the present invention.

FIG. 22 is a perspective view of an N pole integrally-stacked core and an S pole integrally-stacked core according to embodiment 7 of the present invention,

FIG. 23 is a perspective view of a rotor for a rotating electric machine according to embodiment 8 of the present invention.

FIG. 24 is a perspective view of an N pole integrally-stacked core and an S pole integrally-stacked core according to embodiment 8 of the present invention.

FIG. 25 is a perspective view of a rotor for a rotating electric machine according to embodiment 9 of the present invention.

FIG. 26 is a sectional view of the rotor for the rotating electric machine according to embodiment 9 of the present invention.

FIG. 27 is a perspective view of a rotor for a rotating electric machine according to embodiment 10 of the present invention.

FIG. 28 is a perspective view of the rotor, for the rotating electric machine, from which an end surface plate has been removed, according to embodiment 10 of the present invention.

FIG. 29 is a perspective sectional view of the rotor for the rotating electric machine according to embodiment 10 of the present invention.

FIG. 30 is a plan view of the rotor for the rotating electric machine according to embodiment 10 of the present invention.

FIG. 31 is a sectional view of the rotor as taken along a line A-A in FIG. 30.

FIG. 32 is a sectional view of the rotor as taken along a line B-B in FIG. 30.

FIG. 33 is a perspective view of a rotor for a rotating electric machine according to embodiment 11 of the present invention.

FIG. 34 is a plan view of the rotor for the rotating electric machine according to embodiment 11 of the present invention.

FIG. 35 is a perspective view of a rotor for a rotating electric machine according to embodiment 12 of the present invention.

FIG. 36 is a sectional view of the rotor for the rotating electric machine according to embodiment 12 of the present invention.

FIG. 37 is a sectional view of a rotor for a rotating electric machine according to embodiment 13 of the present invention.

FIG. 38 is a sectional view of the rotor for the rotating electric machine according to embodiment 13 of the present invention.

FIG. 39 is a sectional view of a rotating electric machine according to embodiment 1 of the present invention.

### DESCRIPTION OF EMBODIMENTS

### Embodiment 1

Hereinafter, a rotor for a rotating electric machine according to embodiment 1 of the present invention will be described with reference to the drawings.

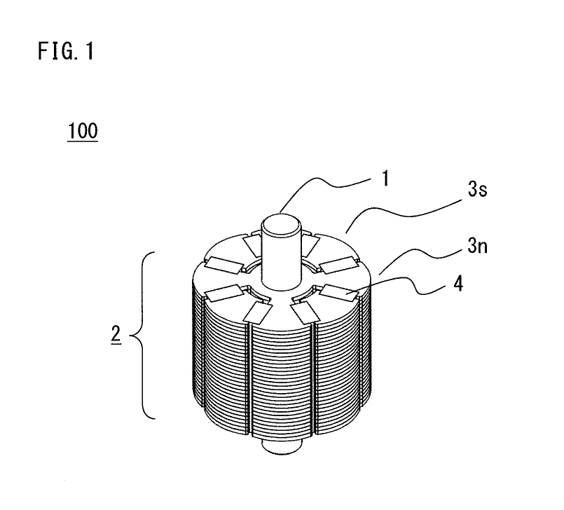

FIG. 1 is a perspective view of a rotor 100.

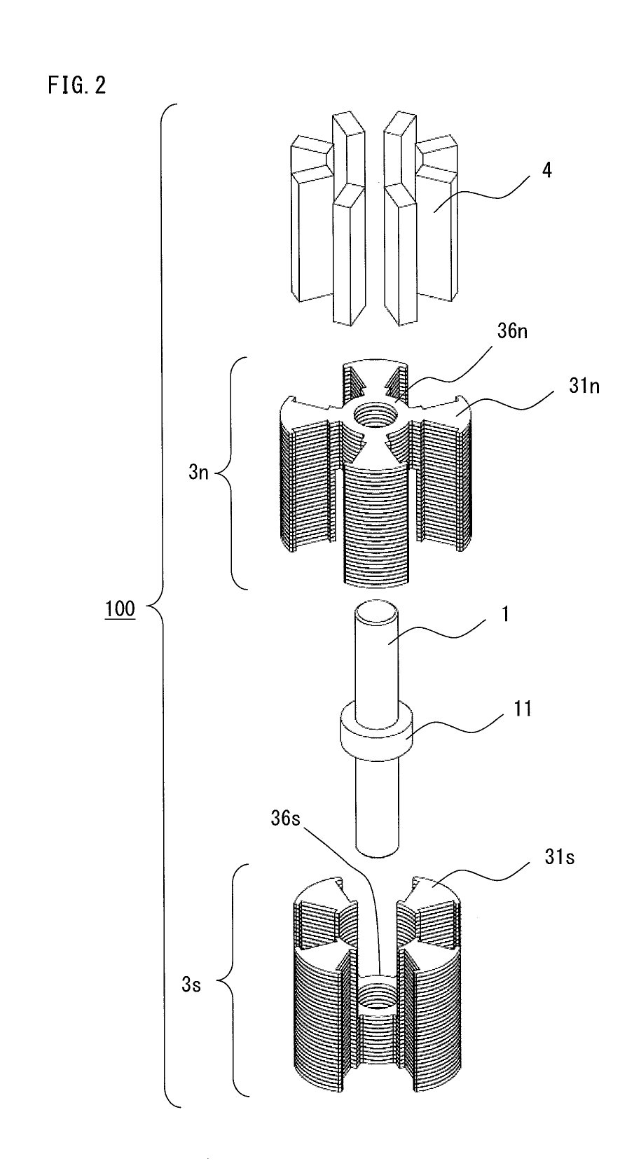

FIG. 2 is an exploded perspective view of the rotor 100.

FIG. 3 is a plan view of the rotor 100.

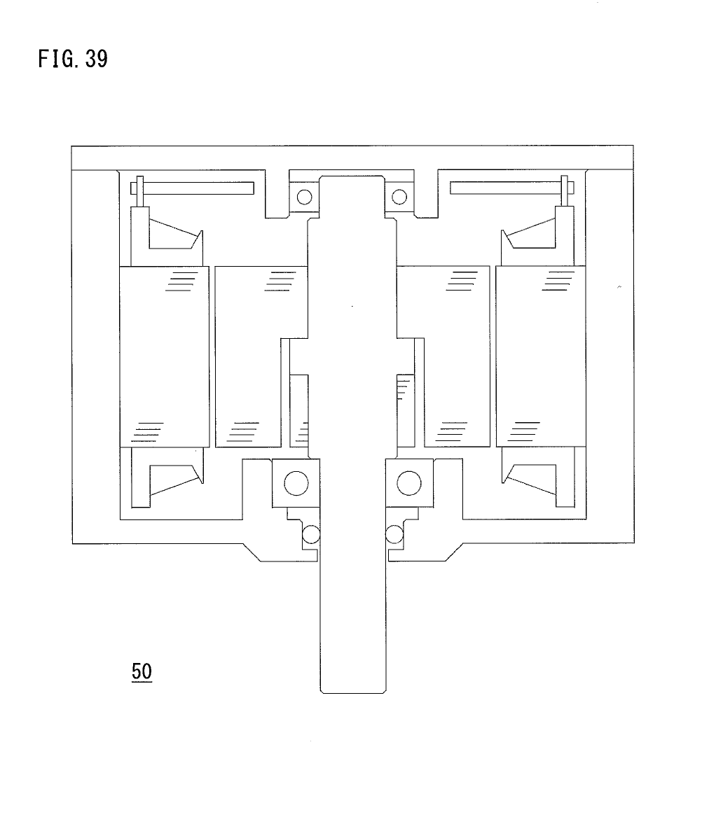

FIG. 39 is a sectional view of an electric motor 50 (rotating electric machine).

The rotor 100 for use in the electric motor 50 (rotating electric machine) shown in FIG. 39 is structured by a non-magnetic rotation shaft 1, a plurality of permanent magnets 4 (first permanent magnets) that are magnetized around the rotation shaft 1 in an alternate manner in the circumferential direction, an N pole integrally-stacked core 3n, and an S pole integrally-stacked core 3s, being combined with each other.

Hereinafter, in the description herein, although the N pole integrally-stacked core 3n and the S pole integrally-stacked core 3s are represented by individual names, respectively, the N pole integrally-stacked core 3n and the S pole integrally-stacked core 3s have the same structure.

Further, in the description herein, a component in which the N pole integrally-stacked core 3n and the S pole integrally-stacked core 3s are combined with each other is referred to as a stacked core 2.

The N pole integrally-stacked core 3n and the S pole integrally-stacked core 3s are distinguished from each other by a polarity of the permanent magnets 4 that are closely attached to both side surfaces, in the circumferential direction, of each corresponding stacked tooth portion.

An integrally-stacked core in which the N pole of the permanent magnets 4 is closely attached to both side surfaces of the stacked tooth portion is defined as the N pole integrally-stacked core 3n, and an integrally-stacked core in which the S pole of the permanent magnets 4 is closely attached to both side surfaces of the stacked tooth portion is defined as the S pole integrally-stacked core 3s.

As shown in FIG. 2, the rotor 100 has a structure in which the N pole integrally-stacked core 3n having four stacked tooth portions 31n integrated with each other and the S pole integrally-stacked core 3s having four stacked tooth portions 31s integrated with each other are fitted and fixed from both sides of the non-magnetic rotation shaft 1 that has a flange portion 11 (interfering member) at its center, by press fitting, shrink fitting, or the like, such that the stacked tooth portions 31n and the stacked tooth portions 31s are alternated.

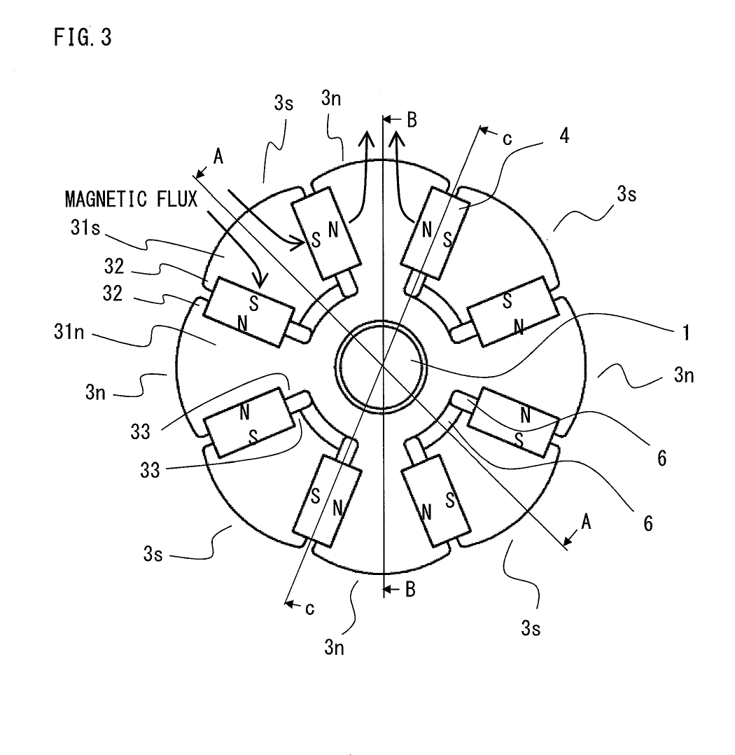

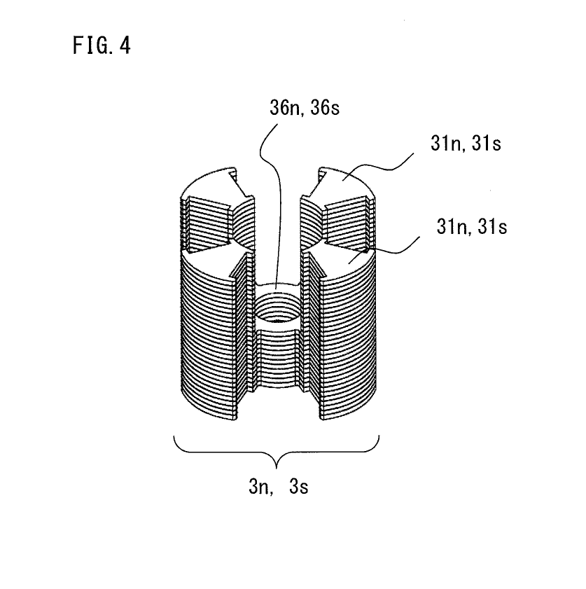

FIG. 4 is a perspective view of the N pole integrally-stacked core 3n and the S pole integrally-stacked core 3s.

As described above, the N pole integrally-stacked core 3n and the S pole integrally-stacked core 3s are structured as the same member, and are illustrated by the same drawings.

FIG. 5 (a) is a plan view of a connecting tooth piece 34 that forms stacking of each of the N pole integrally-stacked core 3n and the S pole integrally-stacked core 3s.

FIG. 5 (b) is a plan view of first tooth pieces 35 that form the stacking of each of the N pole integrally-stacked core 3n and the S pole integrally-stacked core 3s.

FIG. 5 (c) is a plan view illustrating a state where the first tooth pieces 35 are stacked on the connecting tooth piece 34.

Each of the N pole integrally-stacked core 3n and the S pole integrally-stacked core 3s is formed by two kinds of iron core pieces each of which is formed of a magnetic material, as a silicon steel plate or the like.

The first iron core piece is the connecting tooth piece 34 shown in FIG. 5 (a).

The connecting tooth piece 34 is structured so as to include: an annular connecting portion 34a formed in an annular shape at the center; and first tooth portions 34b each of which is almost sector-shaped, and which extend outward from the outer circumference of the annular connecting portion 34a so as to be equally spaced from each other and form a portion of each of the stacked tooth portions 31n, 31s, such that the annular connecting portion 34a and the first tooth portions 34b are integrated with each other.

The second iron core piece is the first tooth piece 35 that is stacked together on the first tooth portions 34b of the connecting tooth piece 34 so as to be aligned with the outer circumference of the first tooth portions 34b.

The first tooth pieces 35 each have almost the same shape as each of the first tooth portions 34b of the connecting tooth piece 34.

The difference therebetween is such that each first tooth piece 35 has such a shape that an end portion of the first tooth portion 34b on the annular connecting portion 34a side (rotation shaft side) is cut in the circumferential direction of the rotor 100 with a predetermined width.

Each of the stacked tooth portion 31n and the stacked tooth portion 31s has a structure in which a predetermined number of the connecting tooth pieces 34 are stacked so as to reach a length that is less than or equal to half the entire length, in the axial direction, of the stacked core 2 (connecting tooth piece stacking step), and a predetermined number of the first tooth pieces 35 are further stacked on the four first tooth portions 34b, respectively, in the axial direction of the rotor 100 (first tooth piece stacking step).

A portion in which the annular connecting portions 34a of the connecting tooth pieces 34 are stacked is defined as a stacked annular connecting portion 36n, 36s, and a portion in which the first tooth portions 34b of the connecting tooth pieces 34 and the first tooth pieces 35 are stacked is defined as the stacked tooth portion 31n, 31s.

Next, a method for assembling the rotor 100 will be described in detail.

As shown in FIG. 2, the stacked annular connecting portions 36n, 36s of the N pole integrally-stacked core 3n and the S pole integrally-stacked core 3s, respectively, are fitted to the rotation shaft 1 from both ends of the rotation shaft 1 so as to contact with the flange portion 11 such that the stacked annular connecting portions 36n, 36s are disposed on the outer side, and the stacked tooth portions 31n, 31s are alternated in a facing manner and are equally spaced from each other (stacked core fitting step).

The N pole integrally-stacked core 3n and the S pole integrally-stacked core 3s include: the stacked annular connecting portions 36n, 36s, respectively, each having almost a cylindrical shape; and the stacked tooth portions 31n, 31s that are stacked around the stacked annular connecting portions 36n, 36s so as to be partially integral with and concentric with the stacked annular connecting portions 36n, 36s, respectively.

The center hole of each connecting tooth piece 34 that forms the annular stacked connecting portions 36n, 36s is accurately formed in advance by a die-stamping step of stamping the stacked teeth.

Therefore, the outer circumferential surfaces of the N pole integrally-stacked core 3n and the S pole integrally-stacked core 3s are positioned so as to be concentric with the axis of the rotation shaft 1 only by the N pole integrally-stacked core 3n and the S pole integrally-stacked core 3s being fitted to the rotation shaft 1, and the N pole integrally-stacked core, the S pole integrally-stacked core, and the rotation shaft 1 can be fitted to each other and assembled so as to advantageously exhibit concentricity.

Thereafter, each permanent magnet 4 is inserted from the rotation shaft direction so as to be closely attached to side surfaces of the stacked tooth portions 31n, 31s of which the side surfaces, respectively, are adjacent to each other (permanent magnet inserting step).

Each permanent magnet 4 is sandwiched between the stacked tooth portions 31n, 31s, and fixed thereto by an adhesive, varnish, or the like.

When the entire length, in the axial direction, of the stacked core 2 is long, two permanent magnets that are separate in the rotation shaft direction may be used.

As shown in FIG. 1 and FIG. 3, the permanent magnets 4 are disposed so as to have polarities such that the N pole is formed in close contact with both side surfaces of each stacked tooth portion 31n of the N pole integrally-stacked core 3n, and the S pole is formed in close contact with both side surfaces of each stacked tooth portion 31s of the S pole integrally-stacked core 3s.

Namely, the polarities of the permanent magnets 4 adjacent to each other are formed so as to be alternately reversed in the circumferential direction of the rotor 100.

As shown in FIG. 3, each permanent magnet 4 is positioned in the radial direction of the stacked core 2 and fixed by means of outer hooks 32 and inner hooks 33 that project, in the circumferential direction of the rotor, from outer circumferential portions and inner circumferential portions of the stacked tooth portions 31n, 31s, so as to correspond to the shape of the permanent magnet 4.

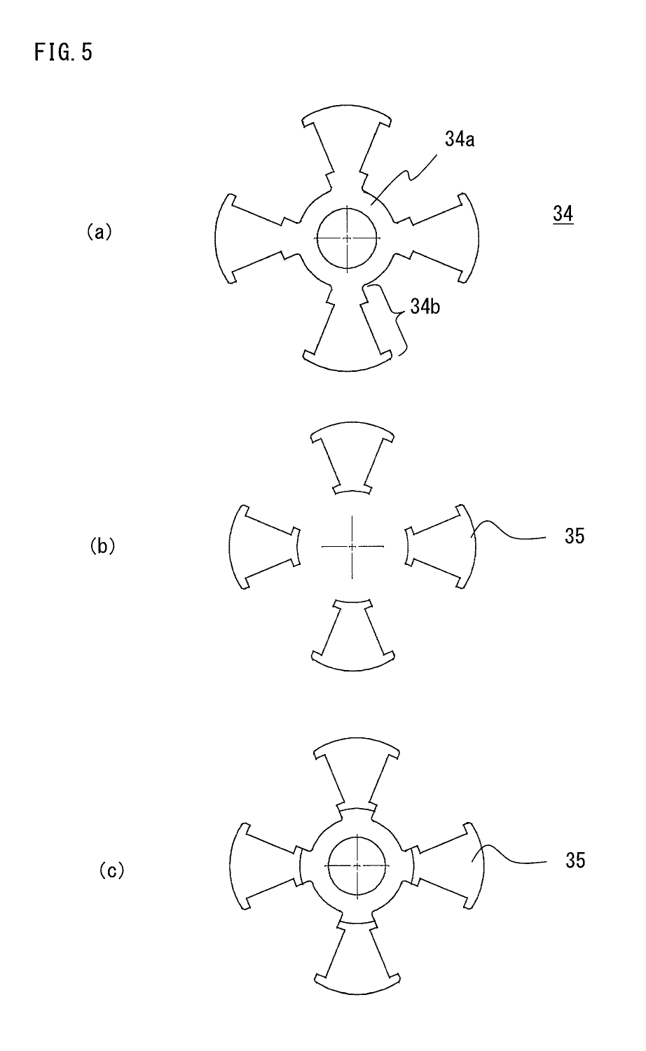

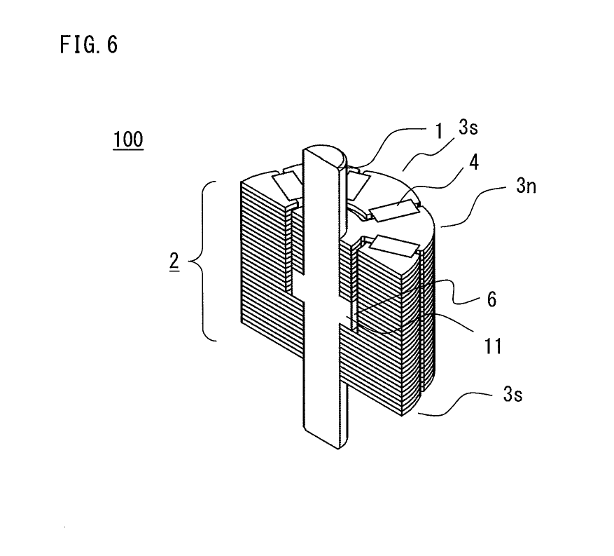

FIG. 6 is a perspective sectional view of the rotor 100 as taken along a line A-A in FIG. 3.

FIG. 7 is a sectional view of the rotor 100 as taken along a line B-B in FIG. 3.

FIG. 8 is a sectional view of the rotor 100 as taken along a line C-C in FIG. 3.

The N pole integrally-stacked core 3n and the S pole integrally-stacked core 3s are assembled so as to have such a positional relationship that the permanent magnet 4 or a gap 6, and the rotation shaft 1 formed of a non-magnetic material are disposed therebetween.

Thus, a structure can be obtained in which short-circuiting of the N pole and the S pole of the permanent magnets 4 due to a magnetic material of the stacked core 2 is prevented.

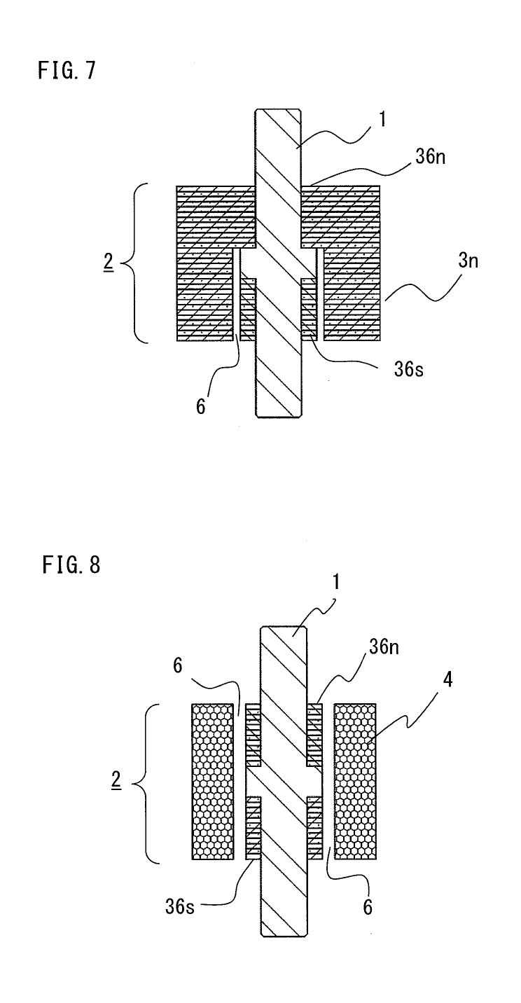

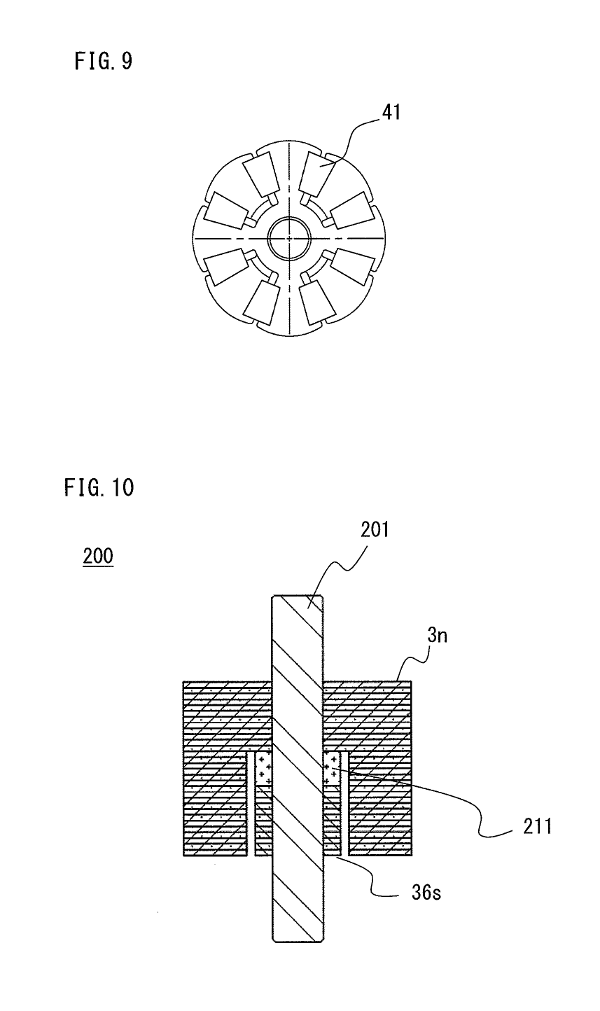

FIG. 9 is a plan view of the rotor 100 in which permanent magnets 41 are used.

As shown in the drawings, the large permanent magnets 41 each having a cross-section expanded outward in the radial direction of the rotor may be used to increase a magnetic flux density.

Further, in the present embodiment, the rotation shaft 1 includes the flange portion 11. However, the flange portion 11 may not be provided, and the stacked annular connecting portions 36n, 36s may be simply fitted and fixed by press fitting, shrink fitting, or the like.

In the rotor 100 for the rotating electric machine according to embodiment 1 of the present invention, one of the permanent magnet 4 or the gap 6, and the rotation shaft 1 formed of a non-magnetic material is disposed between the N pole integrally-stacked core 3n and the S pole integrally-stacked core 3s, and short-circuiting of the N pole and the S pole of the permanent magnets 4 due to a magnetic material, such as an iron core piece, forming the stacking can be prevented.

Even if the number of iron core pieces that cause short-circuiting is one, or even if the one iron core piece is a very small iron core piece having a thickness of a few millimeters, when direct short-circuiting of the N pole and the S pole of the permanent magnets 4 due to the magnetic material occurs, a magnetic flux is concentrated in the portion at which the short-circuiting occurs until the magnetic flux density of the iron core piece is saturated. Therefore, influence of magnetic flux leakage is increased.

In the present invention, a short-circuited magnetic path caused by a magnetic material is never formed between the N pole integrally-stacked core 3n and the S pole integrally-stacked core 3s. Therefore, influence of the magnetic flux leakage that is a problem in a conventional structure can be reduced so as to be negligible.

Further, by a non-magnetic member being used for the rotation shaft 1, a portion where the annular connecting portion 34a and each first tooth portion 34b of the connecting tooth piece 34, which form each of the N pole integrally-stacked core 3n and the S pole integrally-stacked core 3s, are joined to each other, has the same width as the width, in the circumferential direction, of each of the stacked tooth portions 31n, 31s, and the annular connecting portions and the rotation shaft are fitted and fixed by press fitting, shrink fitting, or the like, whereby an accuracy for positioning relative to the rotation shaft 1, and rigidity can be assuredly enhanced.

Thus, rigidity of the N pole integrally-stacked core 3n, the S pole integrally-stacked core 3s, and further the stacked core 2 in which the cores 3n and 3s are combined, can be greatly enhanced.

Further, an outer circumference of the rotor 100 and a not-illustrated stator can be accurately positioned relative to each other.

Further, as compared with, for example, a case where the N pole integrally-stacked core and the S pole integrally-stacked core, and end surface plates that are disposed on the end surfaces, in the axial direction, of each of the N pole integrally-stacked core and the S pole integrally-stacked core, and that are fitted and fixed to the rotation shaft, are assembled and fixed by, for example, tie rods being inserted, or a case where the N pole integrally-stacked core and the S pole integrally-stacked core are fixed to the rotation shaft by integral forming with the use of a mold resin or the like, the number of components that are directly associated with the positioning is reduced, positioning accuracy and the number of assembling process steps are advantageous, concentricity of the rotor 100 and assembling efficiency can be enhanced, and lead time can be shortened.

Further, the rotation shaft 1 formed as a non-magnetic member includes the flange portion. Therefore, since the N pole integrally-stacked core and the S pole integrally-stacked core can be assuredly positioned in the axial direction and fixed, rigidity of the stacked core 2 can be enhanced, and direct short-circuiting of the N pole and the S pole can be assuredly prevented.

Further, when rigidity of the stacked core 2 is enhanced, assembling efficiency of the permanent magnets 4 can be improved.

Further, since the N pole integrally-stacked core 3n and the S pole integrally-stacked core 3s each has a high rigidity, handling of a work, such as conveying and positioning of components, during assembling can be facilitated.

Further, the N pole integrally-stacked core 3n and the S pole integrally-stacked core 3s have the same structure, whereby stamping dies may have a single common structure.

Thus, productivity can be further enhanced.

### Embodiment 2

Hereinafter, a rotor for a rotating electric machine according to embodiment 2 of the present invention will be described with reference to the drawings, focusing on difference from embodiment 1.

The components denoted by the same reference numerals as used in embodiment 1 basically represent the same components.

FIG. 10 is a sectional view of a rotor 200.

In the rotor 200, a non-magnetic collar 211 that is a separate member is fitted around a non-magnetic rotation shaft 201, and the rotation shaft 201 is formed as a member having the same shape as the rotation shaft 1 of embodiment 1.

In such a structure, the usage of an expensive non-magnetic material can be reduced as compared with embodiment 1.

Further, assembling process steps of sequentially fitting the N pole integrally-stacked core 3n, the non-magnetic collar 211, and the S pole integrally-stacked core 3s, to the non-magnetic rotation shaft 201 can be adopted, and operability and productivity can be improved by the one way assembling.

### Embodiment 3

Hereinafter, a rotor for a rotating electric machine according to embodiment 3 of the present invention will be described with reference to the drawings, focusing on difference from embodiment 2.

The components denoted by the same reference numerals as used in embodiment 1 or 2 basically represent the same components.

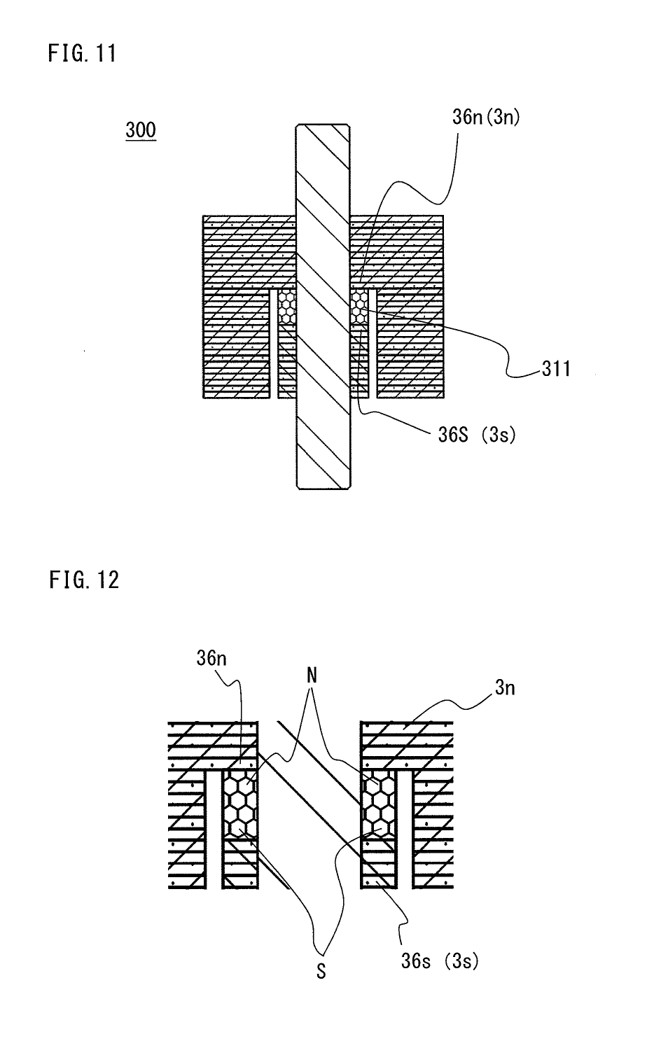

FIG. 11 is a sectional view of a rotor 300.

FIG. 12 is an enlarged view of a specific portion in FIG. 11.

In the rotor 300, a cylindrical permanent magnet 311 (second permanent magnet) is fitted around the non-magnetic rotation shaft 201, and the rotation shaft 201 and the cylindrical permanent magnet 311 have the same shape as the rotation shaft 1 of embodiment 1.

As shown in FIG. 12, the permanent magnet 311 is magnetized so as to have the N pole on a side on which the permanent magnet 311 contacts with the stacked annular connecting portion 36n of the N pole integrally-stacked core 3n, and have the S pole on a side on which the permanent magnet 311 contacts with the stacked annular connecting portion 36s of the S pole integrally-stacked core 3s.

In addition to the effect described in embodiment 2, an effect can be obtained that, by the cylindrical permanent magnet 311 being disposed between the N pole integrally-stacked core 3n and the S pole integrally-stacked core 3s, a magnetic flux passing through the N pole integrally-stacked core 3n and the S pole integrally-stacked core 3s that are formed of a magnetic material can be enhanced. Thus, a magnetic flux density between surfaces, facing each other, of the stacked core 2 and a not-illustrated stacked stator core, can be enhanced.

As in a structure of a conventional rotor, also when, for example, the stacked cores are combined in multiple stages in the rotation shaft direction and a cylindrical permanent magnet is disposed between the stacked cores, a magnetic flux passing through the N pole integrally-stacked core and the S pole integrally-stacked core can be enhanced.

However, in this case, the stacked cores are difficult to dispose outside the cylindrical permanent magnet in the radial direction, and a magnetic flux cannot pass on an outer circumferential surface of the rotor, which faces an inner circumferential surface of a stator, at a position outside the cylindrical permanent magnet in the radial direction.

In the structure of the present embodiment, also at a position outside the cylindrical permanent magnet 311 in the radial direction, the N pole integrally-stacked core 3n and the S pole integrally-stacked core 3s can be disposed. Therefore, a magnetic flux can pass between the rotor and the inner circumferential surface of the stator over the entire length, in the axial direction, of the stacked core 2 of the rotor 100.

### Embodiment 4

Hereinafter, a rotor for a rotating electric machine according to embodiment 4 of the present invention will be described with reference to the drawings, focusing on difference from embodiments 1 to 3.

The components denoted by the same reference numerals as used in embodiments 1 to 3 basically represent the same components.

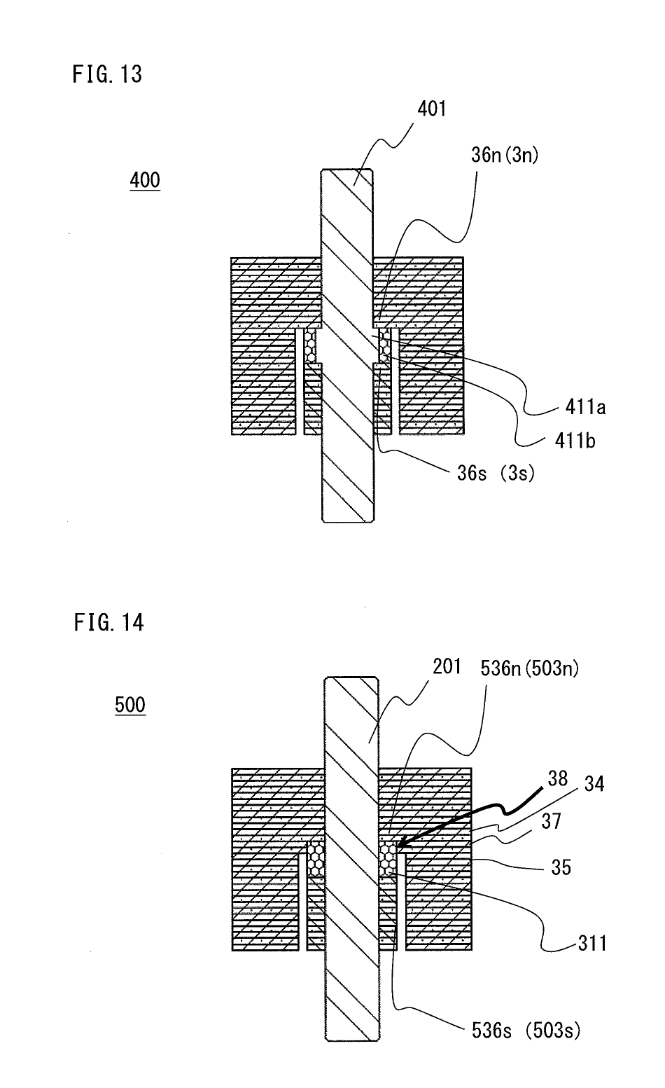

FIG. 13 is a sectional view of a rotor 400.

In the rotor 400, a cylindrical permanent magnet 411b (second permanent magnet) is disposed on the outer circumference of a flange portion 411a disposed in a non-magnetic rotation shaft 401.

The length, in the rotation shaft 401 direction, of the flange portion 411a is slightly greater than the length, in the same direction, of the permanent magnet 411b.

In such a structure, in addition to the effects described in embodiments 1 to 3, an effect can be obtained that positioning of the N pole integrally-stacked core 3n and the S pole integrally-stacked core 3s can be performed through the flange portion 411a, and a magnetic flux passing through the N pole integrally-stacked core 3n and the S pole integrally-stacked core 3s can be enhanced by means of the cylindrical permanent magnet 411b, whereby load is not applied to the permanent magnet 411b during assembling.

Thus, damage of the permanent magnet 411b can be prevented during the assembling, and precise load control becomes unnecessary, thereby improving assembling efficiency of the rotor 400.

### Embodiment 5

Hereinafter, a rotor for a rotating electric machine according to embodiment 5 of the present invention will be described with reference to the drawings, focusing on difference from embodiments 1 to 4.

The components denoted by the same reference numerals as used in embodiments 1 to 4 basically represent the same components.

FIG. 14 is a sectional view of a rotor 500.

In each of an N pole integrally-stacked core 503n and an S pole integrally-stacked core 503s, a predetermined number of second tooth pieces 37 are stacked between the connecting tooth piece 34 and the first tooth pieces 35.

An end portion of each second tooth piece 37 on the rotation shaft 201 side forms a fitting portion 38 that is shaped so as to fit to the outer circumference of the cylindrical permanent magnet 311, and that has a length which is less than or equal to half the length, in the axial direction, of the cylindrical permanent magnet 311.

The circumference of the permanent magnet 311 fits to the fitting portion 38.

The fitting portion 38 can be formed by a predetermined number of the second tooth pieces 37 having the same shape as the first tooth portion 34b of the connecting tooth piece 34 being stacked between the connecting tooth piece 34 and the first tooth pieces 35 that form each of the N pole integrally-stacked core 503n and the S pole integrally-stacked core 503s.

In such a structure, a magnetic flux density can be reduced near the end surfaces, in the rotation shaft direction, of the cylindrical permanent magnet 311 and the outer circumferential portion thereof in which a magnetic flux density is likely to become high, whereby magnetic flux leakage can be further reduced.

### Embodiment 6

Hereinafter, a rotor for a rotating electric machine according to embodiment 6 of the present invention will be described with reference to the drawings, focusing on difference from embodiments 1 to 5.

The components denoted by the same reference numerals as used in embodiments 1 to 5 basically represent the same components.

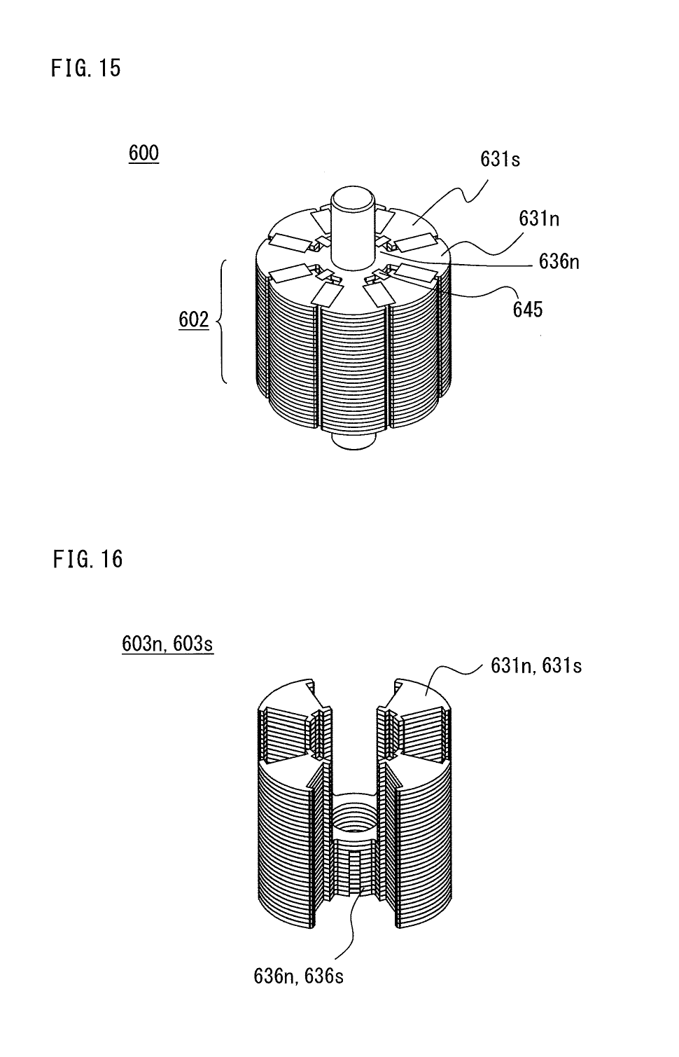

FIG. 15 is a perspective view of a rotor 600.

FIG. 16 is a perspective view of an N pole integrally-stacked core 603n and an S pole integrally-stacked core 603s that form the rotor 600. Both the cores have the same structure, and are illustrated by the same drawings.

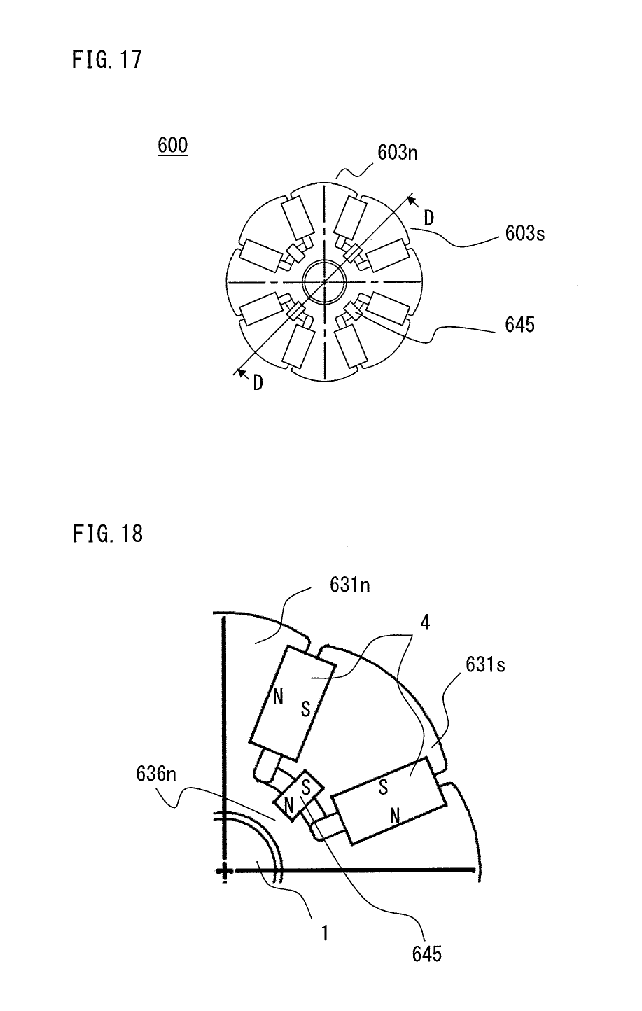

FIG. 17 is a plan view of the rotor 600.

FIG. 18 is an enlarged view of a specific portion in FIG. 17.

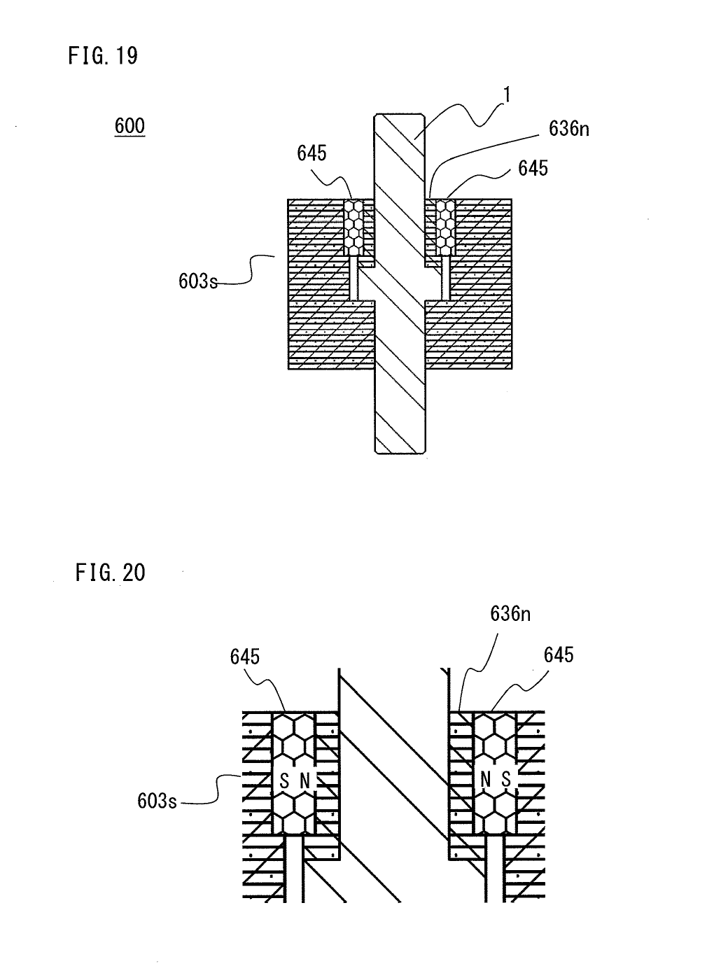

Further, FIG. 19 is a sectional view as taken along a line D-D in FIG. 17. FIG. 20 is an enlarged view of a specific portion in FIG. 19.

In the present embodiment, other permanent magnets 645 (third permanent magnet) are disposed between a stacked annular connecting portion 636n of the N pole integrally-stacked core 603n and a stacked tooth portion 631s of the S pole integrally-stacked core 603s, and between a stacked annular connecting portion 636s of the S pole integrally-stacked core 603s and a stacked tooth portion 631n of the N pole integrally-stacked core 603n.

In such a structure, a magnetic flux that passes through the N pole integrally-stacked core 603n and the S pole integrally-stacked core 603s can be enhanced, and a magnetic flux density between surfaces, facing each other, of a stacked core 602 and a not-illustrated stacked stator core, can be enhanced.

### Embodiment 7

Hereinafter, a rotor for a rotating electric machine according to embodiment 7 of the present invention will be described with reference to the drawings, focusing on difference from embodiments 1 to 6.

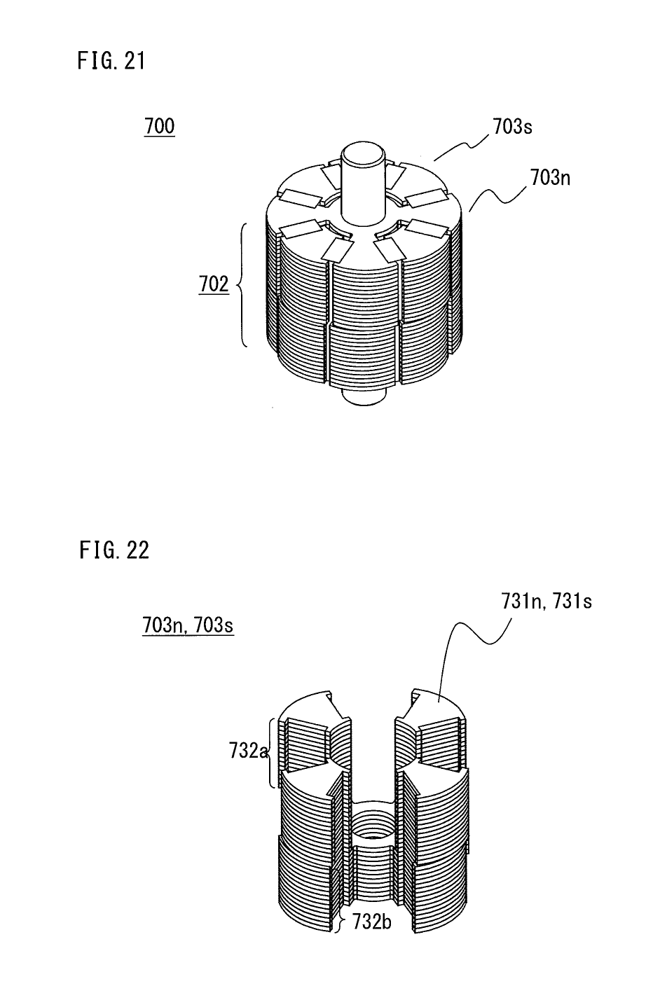

FIG. 21 is a perspective view of a rotor 700.

FIG. 22 is a perspective view of an N pole integrally-stacked core 703n and an S pole integrally-stacked core 703s that form the rotor 700. Both the cores have the same structure, and are illustrated by the same drawings.

In stacked tooth portions 731n, 731s of the N pole integrally-stacked core 703n and the S pole integrally-stacked core 703s, respectively, the circumferential length of the outer hook portion is changed in at least one portion, in the axial direction, of a stacked core 702.

As shown in the drawings, an outer hook 732a is formed so as to be longer than an outer hook 732b. Thus, the outer circumferential surface (an outer circumferential portion of the stacked tooth portion) of the rotor 700 is skewed in one circumferential direction of the rotor 700.

When a width by which the outer hook is skewed, is less than the size of a gap, in the circumferential direction, between adjacent outer hooks, the stacked tooth portions 731n, 731s of the N pole integrally-stacked core 703n and the S pole integrally-stacked core 703s can be alternated, and contact between the N pole integrally-stacked core 703n and the S pole integrally-stacked core 703s can be prevented.

In such a structure, a discontinuous shift as is formed between the stacked tooth portions 31n, 31s in embodiment 1 can be changed to a continuous one on a surface, of the stacked core 702, which faces a not-illustrated stacked stator core, whereby a torque ripple component of the rotor 700 can be reduced.

### Embodiment 8

Hereinafter, a rotor for a rotating electric machine according to embodiment 8 of the present invention will be described with reference to the drawings, focusing on difference from embodiments 1 to 7.

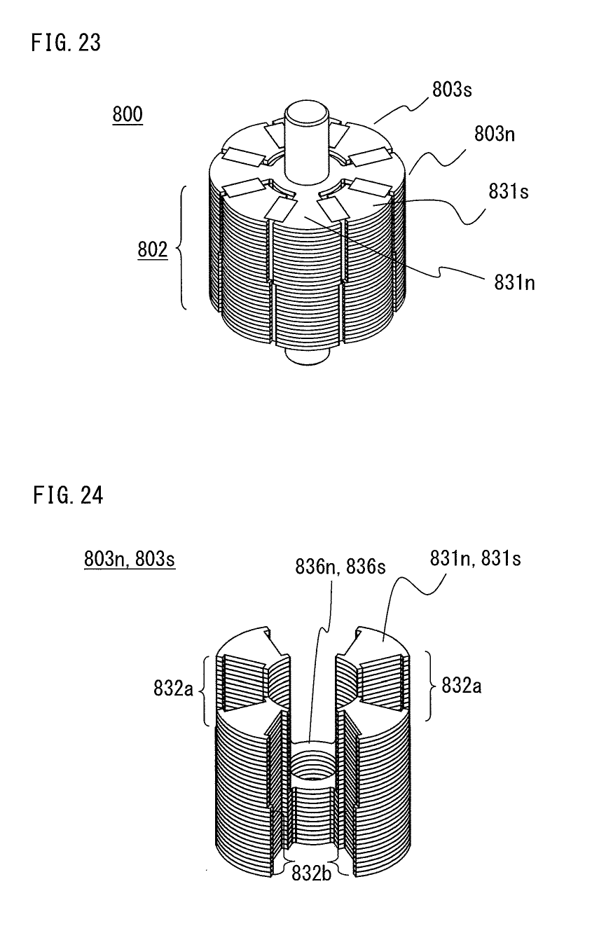

FIG. 23 is a perspective view of a rotor 800.

FIG. 24 is a perspective view of an N pole integrally-stacked core 803n and an S pole integrally-stacked core 803s that form the rotor 800. Both the cores have the same structure, and are illustrated by the same drawings.

In at least one portion, in the axial direction of a stacked core 802, of each of a stacked tooth portion 831n of the N pole integrally-stacked core 803n, and a stacked tooth portion 831s of the S pole integrally-stacked core 803s, the projecting length, in the circumferential direction, of the outer hooks of each of the stacked tooth portions 831n, 831s is reduced stepwise from an end portion side on which the stacked annular connecting portion is formed, toward an end portion side on which no stacked connecting annular portion is formed.

Namely, a projecting distance, in the circumferential direction, of an outer hook 832b shown in FIG. 24 is greater than a projecting distance, in the circumferential direction, of an outer hook 832a.

The other shapes are the same as described for embodiment 1.

For example, when the stacked tooth portions 831n, 831s each include outer hooks that are shortened in three steps, the end portions of the outer hooks of the two stacked tooth portions 831n, 831s adjacent to each other can overlap each other in the circumferential direction as viewed in the axial direction of the rotor 800.

Thus, a discontinuous shift as is formed between the stacked tooth portions 31n, 31s in embodiment 1 can be changed to a completely continuous one on a surface, of the stacked core 802, which faces a not-illustrated stacked stator core, whereby a torque ripple component of the rotor 800 can be reduced.

### Embodiment 9

Hereinafter, a rotor for a rotating electric machine according to embodiment 9 of the present invention will be described with reference to the drawings, focusing on difference from embodiment 1.

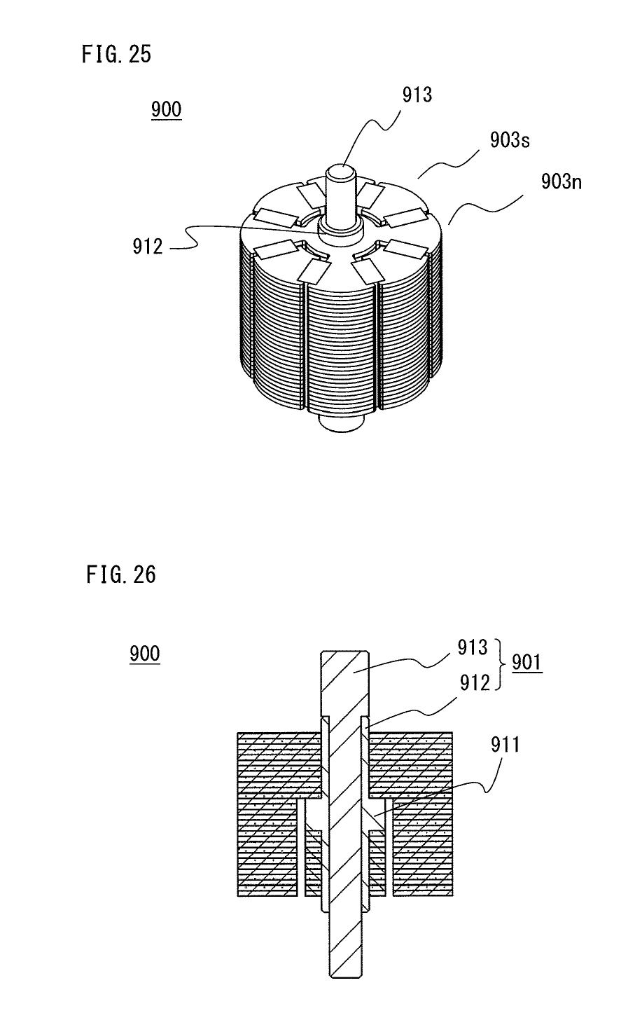

FIG. 25 is a perspective view of a rotor 900.

FIG. 26 is a sectional view of the rotor 900.

As shown in the drawings, a rotation shaft 901 is formed by a magnetic iron-based shaft 913 being inserted in a non-magnetic pipe 912.

The non-magnetic pipe 912 may include a flange portion 911 as shown in FIG. 26, or the non-magnetic pipe may be combined with a non-magnetic collar.

In such a structure, the rotor 900 can be structured without disposing a magnetic material among an N pole integrally-stacked core 903n, an S pole integrally-stacked core 903s, and the iron-based shaft 913.

Further, when the iron-based shaft 913 is used, a yield of an expensive non-magnetic material is enhanced, to improve productivity. Further, various materials to be quenched can be used, thereby enabling enhancement of a strength of the rotor 900.

### Embodiment 10

Hereinafter, a rotor for a rotating electric machine according to embodiment 10 of the present invention will be described with reference to the drawings, focusing on difference from embodiment 1.

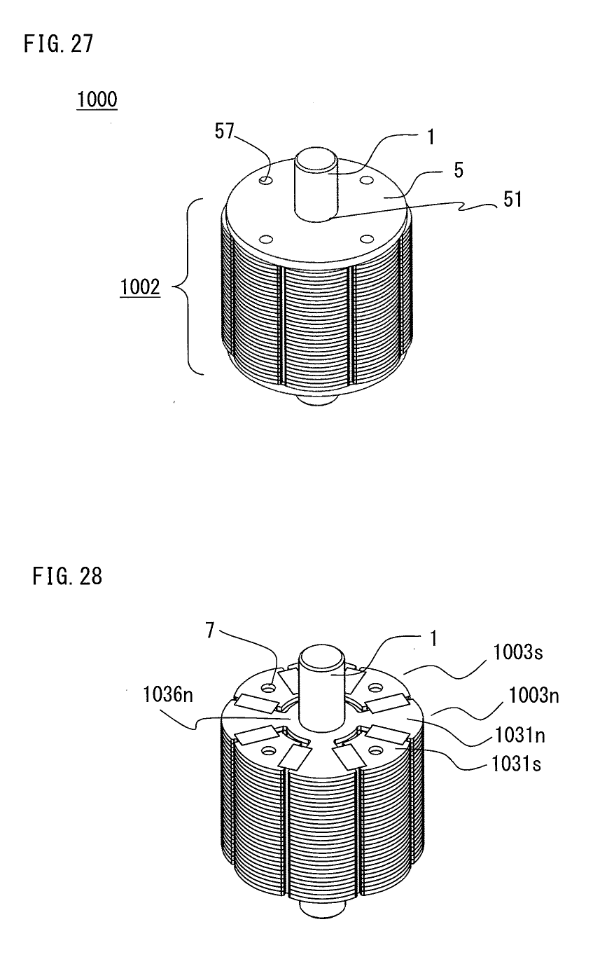

FIG. 27 is a perspective view of a rotor 1000.

FIG. 28 is a perspective view of the rotor 1000 from which an end surface plate has been removed.

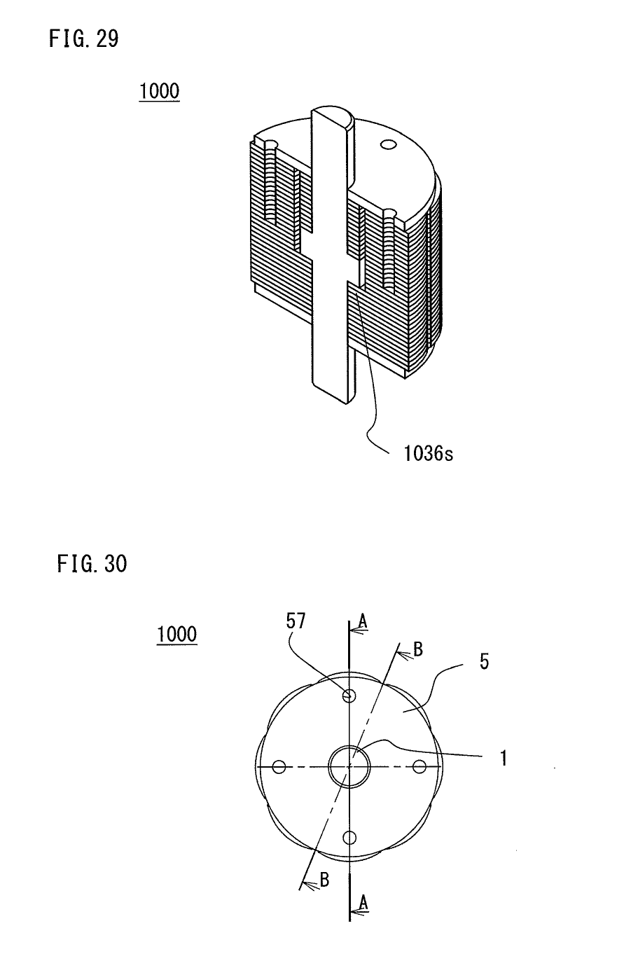

FIG. 29 is a perspective sectional view of the rotor 1000.

FIG. 30 is a plan view of the rotor 1000.

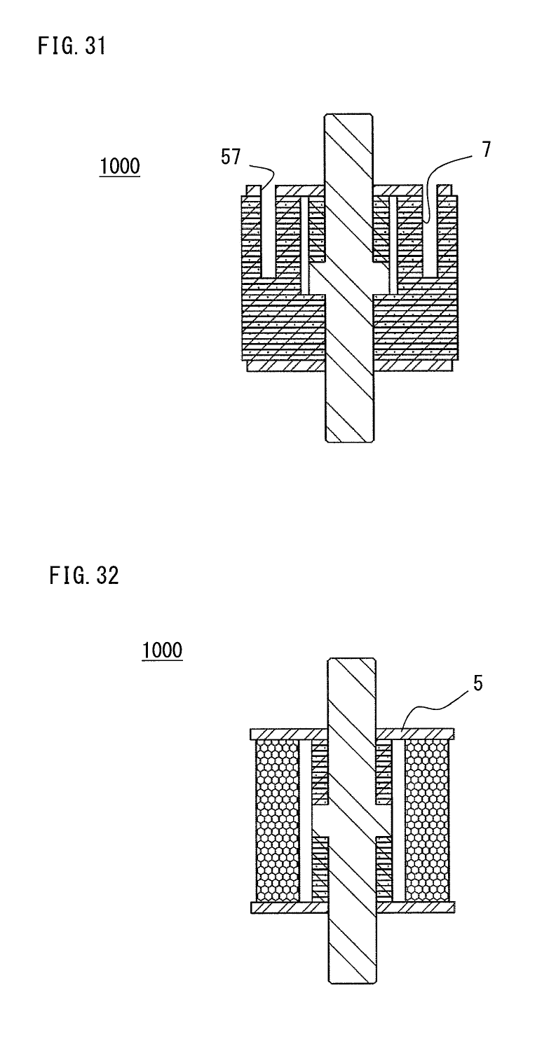

FIG. 31 is a sectional view as taken along a line A-A in FIG. 30.

FIG. 32 is a sectional view as taken along a line B-B in FIG. 30.

As shown in FIG. 27, non-magnetic end surface plates 5 are disposed on the end surfaces in the axial direction of a stacked core 1002, and the non-magnetic end surface plates 5 each have a center hole 51 by which fitting to and positioning relative to the non-magnetic rotation shaft 1 can be performed.

As shown in FIG. 28, in one end surface of a stacked tooth portion of each of an N pole integrally-stacked core 1003n and an S pole integrally-stacked core 1003s, holes 7 are formed, and holes 57 are formed in the end surface plates 5 so as to be aligned with the holes 7. Positioning pins are inserted and fitted into the holes 7, or bolts are inserted and screwed into the holes 7, to fix the end surface plates 5 to the end surfaces of the stacked core 1002.

The holes 7 formed in the N pole integrally-stacked core 1003n and the S pole integrally-stacked core 1003s may have a depth that is less than the entire length, in the axial direction, of the stacked core 1002, or may pass through the stacked core 1002 in the rotation shaft direction as appropriate. In this case, bolts may be inserted and fixed by nuts, or fixing by rivets may be performed.

In such a structure, in stacked tooth portions 1031n, 1031s that project, in the rotation shaft direction, from stacked annular connecting portions 1036n, 1036s of the N pole integrally-stacked core 1003n and the S pole integrally-stacked core 1003s, the non-magnetic end surface plates 5 and the stacked core 1002 can be positioned and fixed, whereby enabling further enhancement of rigidity and assembling accuracy.

The N pole integrally-stacked core 1003n and the S pole integrally-stacked core 1003s are fitted to and positioned relative to the non-magnetic rotation shaft 1 in the stacked annular connecting portions 1036n, 1036s, thereby enhancing rigidity.

When rigidity is enhanced with the use of the holes 7, the holes 7 may not necessarily pass through the stacked core 1002. Insertion and fixing by positioning pins having a short axial length is performed, to reduce insertion counterforce, thereby enhancing assembling efficiency.

### Embodiment 11

Hereinafter, a rotor for a rotating electric machine according to embodiment 11 of the present invention will be described with reference to the drawings, focusing on difference from embodiment 1.

The components denoted by the same reference numerals as used in embodiments 1 to 10 basically represent the same components.

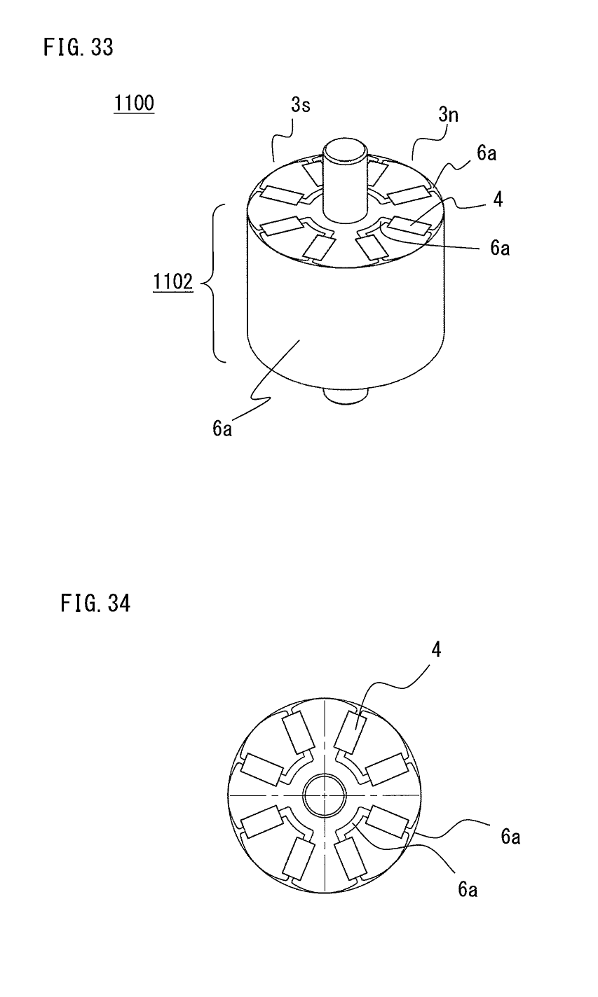

FIG. 33 is a perspective view of a rotor 1100.

FIG. 34 is a plan view of the rotor 1100.

In the gap 6 among the components of the permanent magnets 4, the N pole integrally-stacked core 3n and the S pole integrally-stacked core 3s, and the non-magnetic rotation shaft 1 of the stacked core 1102, and on an outer circumferential surface of the rotor 1100, a mold resin 6a is loaded and applied.

In such a structure, the permanent magnets 4 are fixed by means of an adhesive or the like as described in embodiment 1, and further a fixing force for fixing the permanent magnets 4 is enhanced also by means of the mold resin 6a, thereby enabling enhancement of rigidity of the stacked core 1102.

When the fixing force for fixing the permanent magnets 4 by means of the mold resin 6a is sufficient, the adhering and fixing step for the permanent magnets 4 in the assembling process may be skipped.

### Embodiment 12

Hereinafter, a rotor for a rotating electric machine according to embodiment 12 of the present invention will be described with reference to the drawings, focusing on difference from embodiment 1.

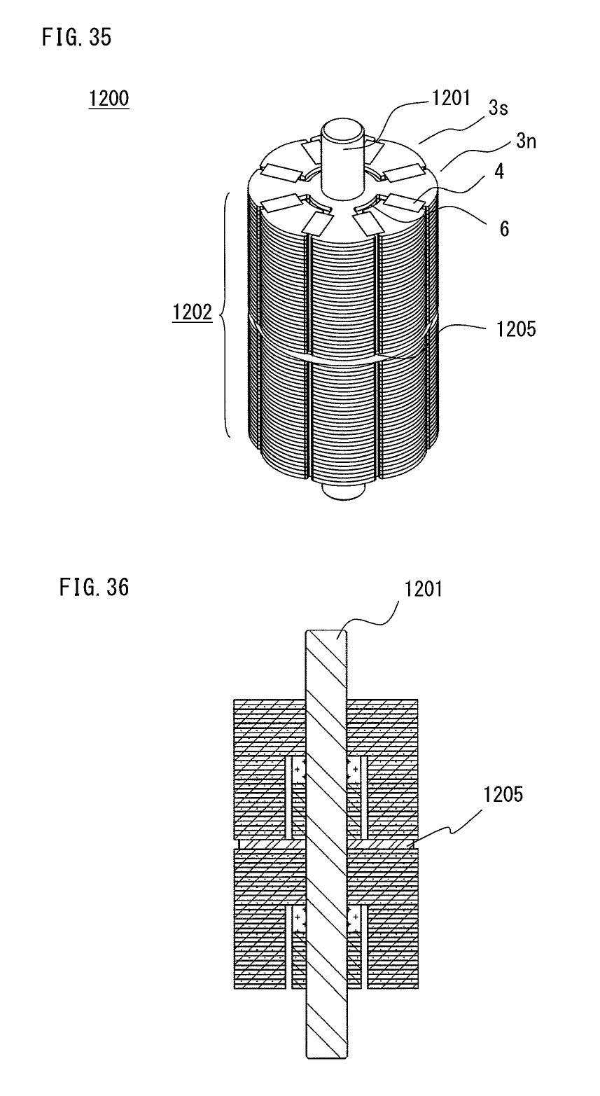

FIG. 35 is a perspective view of a rotor 1200.

FIG. 36 is a sectional view of the rotor 1200.

A stacked core 1202 of the present embodiment has a structure in which one set of module is formed by the N pole integrally-stacked core 3n, the S pole integrally-stacked core 3s, and the permanent magnets 4, and a plurality of the modules are combined for a non-magnetic rotation shaft 1201.

In the drawings, a non-magnetic intermediate plate 1205 for positioning the permanent magnets 4 is sandwiched. However, the plate may not be provided.

In such a structure, by only the length of the non-magnetic rotation shaft being changed, and the stacked core 1202 being formed simply by the modules being combined in multiple steps, a common production line is utilized to manufacture the rotors 1200 for electric motors having different outputs, thereby enhancing productivity.

### Embodiment 13

Hereinafter, a rotor 1300 for a rotating electric machine according to embodiment 13 of the present invention will be described with reference to the drawings, focusing on difference from embodiment 1.

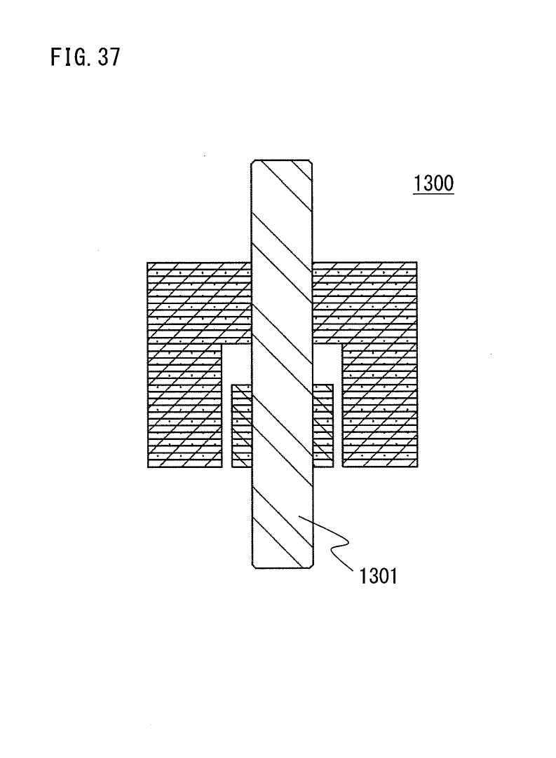

FIG. 37 is a sectional view of the rotor 1300.

The rotor 1300 includes a non-magnetic rotation shaft formed by the flange portion being removed from the rotation shaft 1 of embodiment 1.

In such a structure, as compared with embodiments 1 and 2, usage of an expensive non-magnetic material can be reduced.

In the structure of the present embodiment, a gap is formed between a portion where the N pole integrally-stacked core 3n is fitted to a rotation shaft 1301 and a portion where the S pole integrally-stacked core 3s is fitted to the rotation shaft 1301.

Therefore, there is a concern that, due to a magnetic attraction force generated between the N pole integrally-stacked core 3n and the S pole integrally-stacked core 3s, the N pole integrally-stacked core 3n and the S pole integrally-stacked core 3s may move in the axial direction.

Therefore, the N pole integrally-stacked core 3n and the S pole integrally-stacked core 3s are fixed to the rotation shaft 1301 by press fitting or shrink fitting, or an assembling process for reducing, by adhesion fixing or the like, misalignment in the axial direction is further used in combination, whereby the above concern is solved.

Thus, the non-magnetic collar members can be reduced, thereby further reducing cost.

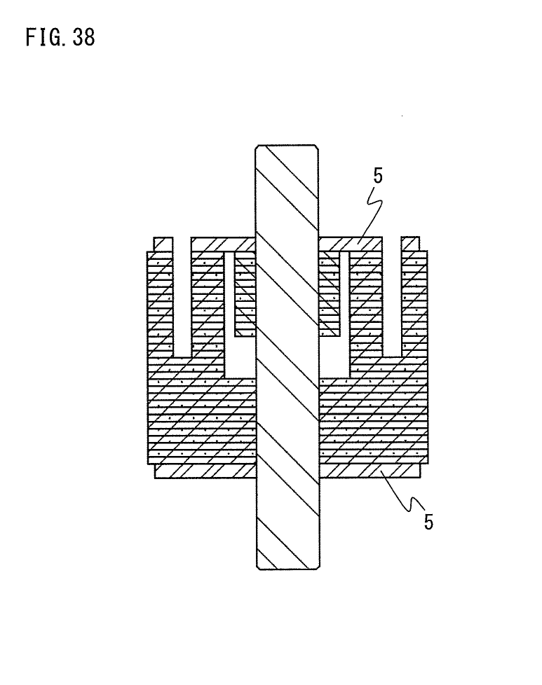

FIG. 38 is a sectional view of the rotor 1300 having end surface plates mounted thereto.

In addition to the structure and assembling process for the rotor 1300 as described above with reference to FIG. 37, the end surface plates 5 are added to both end surfaces, in the axial direction, of each of the N pole integrally-stacked core 3n and the S pole integrally-stacked core 3s as shown in FIG. 38, whereby the N pole integrally-stacked core 3n and the S pole integrally-stacked core 3s can be fixed to each other in the axial direction.

Thus, the N pole integrally-stacked core 3n and the S pole integrally-stacked core 3s can be more assuredly positioned relative to and fixed to the rotation shaft 1301.

Moreover, when the end surface plates 5 are added, an assembling process of fixing the N pole integrally-stacked core 3n and the S pole integrally-stacked core 3s to the rotation shaft 1301 by press fitting, shrink fitting, or another fixing manner such as adhesion, may not be performed.

When the N pole integrally-stacked core 3n and the S pole integrally-stacked core 3s are positioned relative to and fixed to the end surface plates 5 that have been positioned relative to and fixed to the rotation shaft 1301, by means of pins or the like, positioning relative to and fixing to the rotation shaft can be indirectly performed. Thus, the assembling process is simplified, and assembling efficiency and productivity for the rotor 1300 can be enhanced.

It is noted that, within the scope of the present invention, the above embodiments may be freely combined with each other, or each of the above embodiments may be modified or abbreviated as appropriate.

For example, needless to say, also when the number of the stacked teeth forming each of the N pole integrally-stacked cores 3n and the S pole integrally-stacked core 3s is three or five instead of four, the same effect can be obtained.

1. A rotor for a rotating electric machine, comprising:
a plurality of first permanent magnets disposed around a rotation shaft so as to be equally spaced from each other, and magnetized alternately in a circumferential direction; and
a stacked core having a plurality of stacked tooth portions disposed around the rotation shaft so as to sandwich the first permanent magnets from the circumferential direction, and each stacked tooth portion forming a magnetic pole, wherein
the stacked core
includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other,
each of the N pole integrally-stacked core and the S pole integrally-stacked core includes:
a magnetic connecting tooth piece that has: an annular connecting portion which is disposed around the rotation shaft and enables a corresponding one of the integrally stacked cores to be positioned relative to the rotation shaft; and first tooth portions which are equally spaced from each other and disposed so as to project from an outer circumference of the annular connecting portion outward; and
first tooth pieces each of which is magnetic and has a shape formed by an end portion, on the annular connecting portion side, of the first tooth portion being cut in the circumferential direction of the rotation shaft with a predetermined width, and which are stacked so as to be aligned with an outer circumference of the first tooth portions,
in each of the N pole integrally-stacked core and the S pole integrally-stacked core,
the first tooth pieces are stacked on the first tooth portions, of the connecting tooth piece, stacked so as to have a thickness that is less than or equal to half a length, in an axial direction, of the stacked core, and a thickness that is the same between the N pole integrally-stacked core and the S pole integrally-stacked core, such that the first tooth pieces are stacked so as to have a thickness that is the same between the N-pole integrally-stacked core and the S pole integrally-stacked core, and
the N pole integrally-stacked core and the S pole integrally-stacked core are disposed around the rotation shaft having a non-magnetic outer circumferential surface such that the annular connecting portion is disposed on an outer side, and the stacked tooth portions of the N pole integrally-stacked core and the stacked tooth portions of the S pole integrally-stacked core are alternately disposed so as to face each other, and to sandwich the first permanent magnets therebetween.

2. The rotor for the rotating electric machine according to claim 1, wherein the rotation shaft includes an interfering member with which the annular connecting portion of each of the N pole integrally-stacked core and the S pole integrally-stacked core contacts, in an axial direction of the rotation shaft, from both ends.

3. The rotor for the rotating electric machine according to claim 2, wherein the interfering member is a flange portion formed integrally with the rotation shaft.

4. The rotor for the rotating electric machine according to claim 2, wherein the interfering member is a cylindrical non-magnetic collar that is independent of the rotation shaft and is fitted around the rotation shaft.

5. The rotor for the rotating electric machine according to claim 2, wherein the interfering member is a cylindrical second permanent magnet that is fitted around the rotation shaft.

6. The rotor for the rotating electric machine according to claim 2, wherein the interfering member includes: a flange portion formed integrally with the rotation shaft; and a cylindrical second permanent magnet disposed around and fitted to the flange portion.

7. The rotor for the rotating electric machine according to claim 2, comprising a second tooth piece formed between the connecting tooth piece and the first tooth pieces, the second tooth piece having an end portion, in a radial direction, on the rotation shaft side, which fits so as to be along an outer circumferential surface of the interfering member.

8. The rotor for the rotating electric machine according to claim 1, wherein a third permanent magnet is disposed in at least one of a portion between a stacked annular connecting portion of the N pole integrally-stacked core and the stacked tooth portions of the S pole integrally-stacked core, and a portion between a stacked annular connecting portion of the S pole integrally-stacked core and the stacked tooth portions of the N pole integrally-stacked core.

9. The rotor for the rotating electric machine according to claim 1, wherein an outer circumferential portion of the stacked tooth portions is skewed in the circumferential direction.

10. The rotor for the rotating electric machine according to claim 9, wherein an outer hook, formed in the outer circumferential portion of each of the stacked tooth portions, for holding the first permanent magnet, and an outer hook, of the adjacent one of the stacked tooth portions, which faces the outer hook of said each of the stacked tooth portions, have different lengths in the circumferential direction of the rotation shaft.

11. The rotor for the rotating electric machine according to claim 1, wherein, in an outer circumferential portion of the stacked tooth portions, a width in the circumferential direction is reduced stepwise from a side that connects to the annular connecting portion, toward a side that does not connect to the annular connecting portion.

12. The rotor for the rotating electric machine according to claim 11, wherein a length, in the circumferential direction, of the outer hook that is formed in an outer circumferential portion of the stacked tooth portions for holding the first permanent magnet, is reduced stepwise from one end that connects to the annular connecting portion toward the other end that does not connect to the annular connecting portion.

13. The rotor for the rotating electric machine according to claim 1, wherein the rotation shaft is formed by an iron-based shaft being fitted into a non-magnetic pipe.

14. The rotor for the rotating electric machine according to claim 1, wherein
a non-magnetic end surface plate fitted to and positioned relative to the rotation shaft is disposed on an end surface, in the rotation shaft direction, of the stacked core, and
the end surface plate is joined to the stacked tooth portions.

15. The rotor for the rotating electric machine according to claim 1, wherein, in the stacked core, an outer circumferential surface thereof, and a gap formed among the N pole integrally-stacked core, the S pole integrally-stacked core, the first permanent magnets, and the rotation shaft which form the stacked core, are sealed with a mold resin.

16. A rotor for a rotating electric machine comprising a plurality of the stacked cores, according to claim 1, mounted to the rotation shaft.

17. A rotating electric machine comprising a rotor and a stator, wherein
the rotor includes:
a plurality of first permanent magnets disposed around a rotation shaft so as to be equally spaced from each other, and magnetized alternately in a circumferential direction; and
a stacked core having a plurality of stacked tooth portions disposed around the rotation shaft so as to sandwich the first permanent magnets from the circumferential direction, and each stacked tooth portion forming a magnetic pole,
the stacked core
includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other,
each of the N pole integrally-stacked core and the S pole integrally-stacked core includes:
a magnetic connecting tooth piece that has: an annular connecting portion which is disposed around the rotation shaft and enables a corresponding one of the integrally stacked cores to be positioned relative to the rotation shaft; and first tooth portions which are equally spaced from each other and disposed so as to project from an outer circumference of the annular connecting portion outward; and
first tooth pieces each of which is magnetic and has a shape formed by an end portion, on the annular connecting portion side, of the first tooth portion being cut in the circumferential direction of the rotation shaft with a predetermined width, and which are stacked so as to be aligned with an outer circumference of the first tooth portions,
in each of the N pole integrally-stacked core and the S pole integrally-stacked core,
the first tooth pieces are stacked on the first tooth portions, of the connecting tooth piece, stacked so as to have a thickness that is less than or equal to half a length, in an axial direction, of the stacked core, and a thickness that is the same between the N pole integrally-stacked core and the S pole integrally-stacked core, such that the first tooth pieces are stacked so as to have a thickness that is the same between the N-pole integrally-stacked core and the S pole integrally-stacked core, and
the N pole integrally-stacked core and the S pole integrally-stacked core are disposed around the rotation shaft having a non-magnetic outer circumferential surface such that the annular connecting portion is disposed on an outer side, and the stacked tooth portions of the N pole integrally-stacked core and the stacked tooth portions of the S pole integrally-stacked core are alternately disposed so as to face each other, and to sandwich the first permanent magnets therebetween.

18. A method for manufacturing a rotor for a rotating electric machine, wherein
the rotor for the rotating electric machine includes:
a plurality of first permanent magnets disposed around a rotation shaft so as to be equally spaced from each other, and magnetized alternately in a circumferential direction; and
a stacked core having a plurality of stacked tooth portions disposed around the rotation shaft so as to sandwich the first permanent magnets from the circumferential direction, and each stacked tooth portion forming a magnetic pole, and
the stacked core
includes: an N pole integrally-stacked core in which the stacked tooth portions that contact with N pole side portions of adjacent ones of the first permanent magnets are integrated with each other; and an S pole integrally-stacked core which has the same shape as the N pole integrally-stacked core and in which the stacked tooth portions that contact with S pole side portions of adjacent ones of the first permanent magnets are integrated with each other, the method for manufacturing a rotor for a rotating electric machine comprising:
a manufacturing step of manufacturing each of the N pole integrally-stacked core and the S pole integrally-stacked core;
a stacked core fitting step; and
a permanent magnet inserting step, wherein
the manufacturing step includes:
a connecting tooth piece stacking step of stacking magnetic connecting tooth pieces each having an annular connecting portion and first tooth portions, so as to have a thickness that is less than or equal to half a length, in an axial direction, of the stacked core, and a thickness that is the same between the N pole integrally-stacked core and the S pole integrally-stacked core, the annular connecting portion being disposed around the non-magnetic rotation shaft and enabling a corresponding one of the integrally stacked cores to be positioned relative to the rotation shaft, the first tooth portions being equally spaced from each other and disposed so as to project from an outer circumference of the annular connecting portion outward; and
a first tooth piece stacking step of stacking, on the first tooth portions of the connecting tooth pieces, first tooth pieces each of which is magnetic and has a shape formed by an end portion, on the annular connecting portion side, of the first tooth portion being cut in the circumferential direction of the rotation shaft with a predetermined width, such that the first tooth pieces are aligned with an outer circumference of the first tooth portions, and have a thickness that is the same between the N pole integrally-stacked core and the S pole integrally-stacked core, to structure the stacked tooth portions, and
after one of the N pole integrally-stacked core and the S pole integrally-stacked core is positioned relative to and fitted to the rotation shaft such that the annular connecting portion is disposed on an outer side of the rotation shaft,
in the stacked core fitting step, the other of the integrally stacked cores is positioned relative to and fitted to the rotation shaft such that the annular connecting portion is disposed on the outer side of the rotation shaft, and the stacked tooth portions of the N pole integrally-stacked core and the stacked tooth portions of the S pole integrally-stacked core are alternately disposed in the circumferential direction of the rotor at regular intervals so as to face each other, and
in the permanent magnet inserting step, the first permanent magnets are inserted, from an axial direction of the rotation shaft, in spaces formed between the stacked tooth portions of the N pole integrally-stacked core and the stacked tooth portions of the S pole integrally-stacked core, such that an N pole of the first permanent magnets contacts with the N pole integrally-stacked core and an S pole of the first permanent magnets contacts with the S pole integrally-stacked core.
